(19) United States
(12) Patent Application Publication
(10) Pub. No.: US 2015/0002669 A1
(43) Pub. Date: Jan. 1, 2015

(54) TRAILER IDENTIFICATION

(71) Applicant: FORD GLOBAL TECHNOLOGIES, LLC, Dearborn, MI (US)

(72) Inventors: Eric L. Reed, Livonia, MI (US); Roger Arnold Trombley, Ann Arbor, MI (US); John Shutko, Ann Arbor, MI (US)

(21) Appl. No.: 13/928,825

(22) Filed: Jun. 27, 2013

(51) Int. Cl. G06K 9/00; B60R 1/00

(52) U.S. Cl. CPC G06K 9/00791; B60R 1/003
USPC 348/148

(57) ABSTRACT

A system includes a camera that captures an image of a trailer attached to a vehicle and outputs a signal representing the captured image. A user interface device presents the captured image to a user and receives a user input. A processor associates collected vehicle data to the trailer based at least in part on the user input. A method includes capturing the image of the trailer, receiving a signal representing the captured image, presenting the captured image to a user, receiving a user input, and associating, via a processor, collected vehicle data to the trailer based at least in part on the user input.

### BACKGROUND

Trailers require routine maintenance at intervals that are often measured by the number of miles the trailer has been towed. Operators of vehicles that tow multiple trailers may have difficulty tracking the mileage of each trailer. Some vehicles include systems that can track the mileage of each trailer. With such a system, the operator has some confidence that the mileage of each trailer is accurate and easily accessible.

### SUMMARY

An exemplary system includes a camera configured to capture an image of a trailer attached to a vehicle and output a signal representing the captured image. The system further includes a user interface device configured to present the captured image to a user and receive a user input and a processor configured to associate collected vehicle data to the trailer based at least in part on the user input.

An exemplary vehicle includes a trailer, a camera, a user interface device, an odometer, and a processor. The camera is configured to capture an image of the trailer and output a signal representing the captured image. The user interface device is configured to present the captured image to a user and receive a user input. The odometer is configured to track a distance traveled by the vehicle while towing the trailer. The processor is configured to identify the trailer from the captured image and associate the distance traveled by the vehicle to the trailer based at least in part on the user input. The user input confirms that the trailer identified by the processor is the trailer represented by the captured image.

An exemplary method includes capturing an image of a trailer attached to a vehicle, receiving a signal representing the captured image, presenting the captured image to a user, receiving a user input, and associating, via a processor, collected vehicle data to the trailer based at least in part on the user input.

### BRIEF DESCRIPTION OF THE DRAWINGS

FIG. 1 illustrates an exemplary block diagram of a vehicle configured to facilitate the identification of a trailer attached to the vehicle and associated collected data to the identified trailer.

FIG. 2 illustrates a flowchart of an exemplary process that may be implemented by one or more components of the vehicle of FIG. 1 to associate collected data to the identified trailer.

FIG. 3 illustrates a flowchart of an exemplary process that may be implemented by one or more components of the vehicle of FIG. 1 to automatically identify the trailer.

FIG. 4 illustrates a flowchart of an exemplary process that may be implemented by one or more components of the vehicle of FIG. 1 to receive information about a new trailer.

### DETAILED DESCRIPTION

FIG. 1 illustrates an exemplary vehicle 100 configured to track various metrics associated with a trailer towed by the vehicle. The vehicle 100 may take many different forms and include multiple and/or alternate components and facilities. While an exemplary vehicle 100 is shown, the exemplary components illustrated in the Figures are not intended to be limiting. Indeed, additional or alternative components and/or implementations may be used.

As illustrated in FIG. 1, a trailer 105 is attached to the vehicle 100 via, e.g., a hitch 110, and the vehicle 100 includes an odometer 115, a camera 120, a user interface device 125, a memory device 130, and a processor 135.

The odometer 115 may be configured to track a distance traveled by the vehicle 100, the trailer 105, or both. The odometer 115 may be configured to count a number of rotations made by any one or more of the wheels (not shown) of the vehicle 100. The odometer 115 may alternatively use a navigation system, such as the Global Positioning System (GPS) to track a distance traveled by the vehicle 100, the trailer 105, or both.

The camera 120 may be configured to capture an image of the trailer 105 attached to the vehicle 100 and output an image signal representing the captured image. The camera 120 may include an aperture (not shown) that receives and directs light onto a recording surface (not shown). An image sensor may create a virtual representation of the light directed onto the recording surface, and the output of the image sensor may include the signal representing the captured image. The camera 120 may output the image signal electronically or wirelessly to, e.g., the processor 135. The camera 120 may be located anywhere on the vehicle 100 with a line of sight to the trailer 105. For instance, the camera 120 may be located on a rear bumper of the vehicle 100.

The user interface device 125 may be configured to present the captured image, as well as other images, to the user and receive a user input. The user interface device 125 may include a display screen configured to present text, images, etc., to the user. In some possible implementations, the user interface device 125 may include an input device configured to receive an input from the user. In other possible approaches, the user interface device 125 may include a touchscreen display that acts as both the display device and the input device. That is, the touchscreen display may present text, images, selectable options, such as buttons, or the like, to the user, and receive an input from the user when the user touches the touchscreen display. The user interface device 125 may be configured to display requests for information from the user and receive the input from the user following the request. When prompted, the user may provide the requested information through the input device, or in the instance where the user interface device 125 includes a touchscreen display, by touching various portions of the user interface device 125. One example selection received from the user may include a selection of one of the presented images, which as discussed below may include images of known trailers and the captured image.

In some possible approaches, the user interface device 125, and in particular the input device, may be configured to interface with other devices, such as an external camera (e.g., different from the camera 120 discussed above), a memory module, a flash drive, or the like. This way, the user interface device 125 may allow the user to import data, images, or both, from the external source. For example, images of known trailers may be captured using the external camera and stored on an external memory device. Using the user interface device 125, the images of known trailers may be uploaded to, e.g., the memory device 130 of the vehicle 100.

The memory device 130 may be configured to electronically store data, applications, or both. The memory device 130 may be configured to store images of known trailers, including the captured image, as well as information about each of the known trailers. The data and applications stored in the memory device 130 may be accessible to other components of the vehicle 100, such as the user interface device 125 and the processor 135. As discussed above, one or more of the images of known trailers may have been captured by the camera 120 incorporated into the vehicle 100 or by an external source and stored in the memory device 130. Therefore, the images of known trailers may represent a historical collection of all of the captured images of known trailers ever attached to the vehicle 100.

The processor 135 may be configured to associate collected vehicle data, such as the distance traveled by the vehicle 100 as determined by the odometer 115, to the trailer 105 identified in the captured image based, at least in part, on the user input provided to the user interface device 125. The processor 135 may be configured to prompt the user, via the user interface device 125, to confirm, from the images of known trailers, which trailer 105 is currently attached to the vehicle 100. The processor 135 may further cause the user interface device 125 to display the captured image of the current trailer 105 to the user to help guide the user's selection. Upon receipt of the user's selection from the images of known trailers, the processor 135 may begin to apply collected vehicle data to the selected trailer 105.

The processor 135 may be configured to detect the presence of the trailer 105. Some ways to detect the presence of the trailer 105 may include using a proximity sensor (not shown) configured to detect when the trailer 105 is immediately behind the vehicle 100 or when the trailer 105 is connected to the hitch 110 or receiving an input from the user indicating that a trailer 105 is attached to the vehicle 100. The processor 135 may be configured to output a presence signal indicating the presence of the trailer 105. The processor 135 may output the presence signal to the camera 120, and the camera 120 may be configured to capture the image of the trailer 105 upon receipt of the presence signal.

The processor 135 may be further configured to automatically identify the current trailer 105 from the captured image by, e.g., comparing the captured image to images of known trailers stored in the memory device 130. The processor 135 may use one or more image processing techniques to compare the captured image to the images of known trailers. The processor 135 may be configured to identify the current trailer 105 based on similarities between the captured image and one of the images of known trailers. The output of the image processing technique may include a signal representing a degree of similarity between the captured image and one or more of the images of known trailers. The processor 135 may be configured to identify a match if the degree of similarity between the captured image and one of the images of known trailers exceeds a predetermined threshold. Alternatively or in addition, the processor 135 may be configured to select the trailer 105 shown in the image with the highest degree of similarity with the captured image as the selected trailer 105.

The processor 135 may be configured to prompt the user, via the user interface device 125, to confirm that the trailer 105 automatically identified by the processor 135 matches the trailer 105 shown in the captured image. If so, the processor 135 may be configured to associate the automatically selected trailer 105 with at least a subset of collected vehicle data, such as the distance the vehicle 100 has traveled while towing the trailer 105. If the user cannot confirm that the correct trailer 105 was selected, or if no matching trailer 105 could be identified, the processor 135 may be configured to prompt the user to select the correct trailer 105 from the images of known trailers, or alternatively, the processor 135 may be configured to prompt the user, via the user interface device 125, to indicate that the trailer 105 is a new trailer 105. The processor 135 may be further configured to automatically determine whether the trailer 105 is a new trailer 105 if, e.g., the image processing technique discussed above fails to identify a match or if the degrees of similarity between the captured image and the images of known trailers are all below a predetermined threshold.

In some instances, the processor 135 may be configured to prompt the user, via the user interface device 125, to provide information about the trailer 105 represented by the captured image. This may occur, for instance, when the trailer 105 is a new trailer 105 or when a known trailer 105 is selected by the user from the images of known trailers. Moreover, the processor 135 may prompt the user to provide additional information about the trailer 105 after the trailer 105 has been automatically identified by the processor 135. The processor 135 may receive and process a user input, provided to the user interface device 125, that includes the information requested. Moreover, the processor 135 may be configured to store any received information in the memory device 130. In one possible approach, the processor 135 may be configured to associate received information with one or more known trailers by storing the received information in a database that links the information to the trailer 105. Example information that may be requested for one or more trailers 105 may include the name of the trailer 105, an identifier such as a serial number, a make and model of the trailer 105, a date of purchase, maintenance history of the trailer 105, and miscellaneous notes about the trailer 105. Other information may be requested as well.

With the trailer 105 identified, either automatically by the processor 135 or upon selection by the user, the processor 135 can associate collected vehicle data to the trailer 105 currently attached to the vehicle 100 and store the collected data in the memory device 130. An example of the collected vehicle data may include the distance the vehicle 100 has traveled with the trailer 105 attached. Therefore, the vehicle 100 may track the total distance traveled by the trailer 105 with the vehicle 100. Because the user either selects the connected trailer 105 or confirms the trailer 105 automatically selected by the processor 135, the processor 135 is more likely to associate the collected vehicle data with the correct trailer 105, especially in instances where a single vehicle 100 tows different trailers 105 at different times. Thus, the data stored in the memory device 130 may accurately reflect the use of the trailer 105 with the vehicle 100. Moreover, with such data, the user may easily determine when maintenance is required for the trailer 105.

In general, computing systems and/or devices, such as the processor 135, may employ any of a number of computer operating systems, including, but by no means limited to, versions and/or varieties of the Microsoft Windows® operating system, the Unix operating system (e.g., the Solaris® operating system distributed by Oracle Corporation of Redwood Shores, Calif.), the AIX UNIX operating system distributed by International Business Machines of Armonk, N.Y., the Linux operating system, the Mac OS X and iOS operating systems distributed by Apple Inc. of Cupertino, Calif., the BlackBerry OS distributed by Research In Motion of Waterloo, Canada, and the Android operating system developed by the Open Handset Alliance.

Computing devices generally include computer-executable instructions, where the instructions may be executable by one or more computing devices such as those listed above. Computer-executable instructions may be compiled or interpreted from computer programs created using a variety of programming languages and/or technologies, including, without limitation, and either alone or in combination, Java™, C, C++, Visual Basic, Java Script, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of a computer. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer-readable media associated therewith (e.g., disks, memories, etc.). A computer program product may comprise such instructions stored on computer-readable media for carrying out the functions described herein.

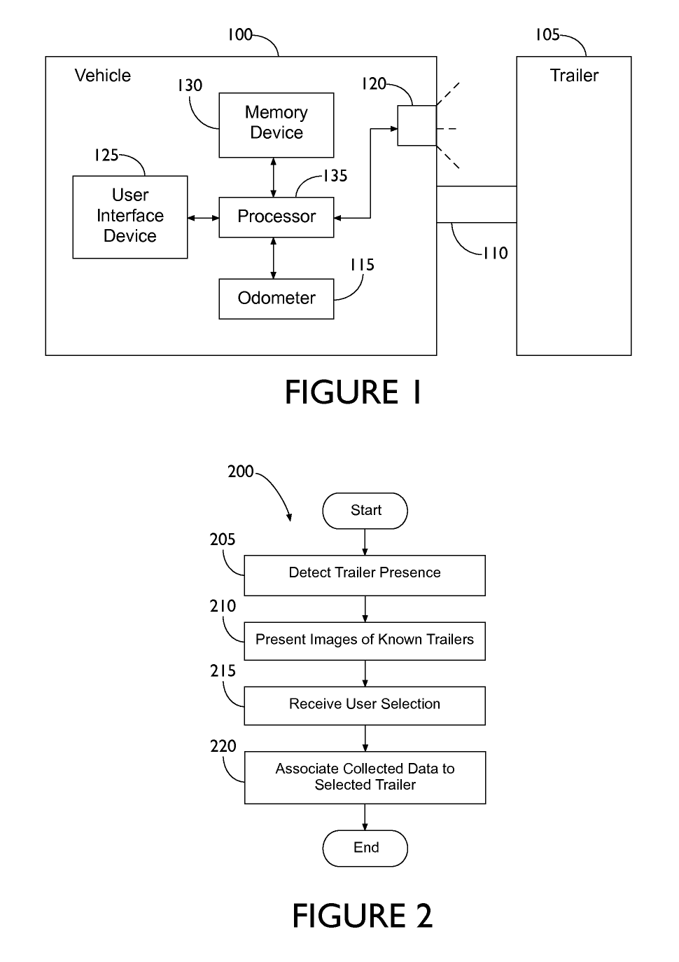

FIG. 2 is a flowchart of an exemplary process 200 that may be implemented by one or more of the vehicle components illustrated in FIG. 1. For example, various parts of the process 200 may be implemented by, e.g., the user interface device 125, the processor 135, or a combination of these or other vehicle components. In the process 200 of FIG. 2, the processor 135 may rely upon the user to select the trailer 105 currently attached to the vehicle 100.

At block 205, the processor 135 may detect the presence of the trailer 105 relative to the vehicle 100. The processor 135 may interpret receipt of the image signal from the camera 120 as indicative of the presence of the trailer 105. Alternatively, as previously discussed, the vehicle 100 may include one or more sensors that determine when the trailer 105 is immediately behind the vehicle 100 or attached to the hitch 110 of the vehicle 100.

At block 210, the user interface device 125 may present images of known trailers to the user. The user interface device 125 may further present information about one or more of the known trailers with one or more images. The user interface device 125 may present the images of known trailers using a display device, which may be included in a touchscreen display. Moreover, as discussed above, the images of known trailers may include a collection of all of the previously captured images. Further, in some possible implementations, the captured image of the presently attached trailer 105 may be presented with the images of known trailers so, e.g., the user has a reference for selecting the correct trailer 105 (i.e., the trailer 105 currently attached to the vehicle 100) at block 215.

At block 215, the processor 135 may receive, via the user interface device 125, a user input representing a selection of one of the images presented at block 210. Specifically, the user input may represent the trailer 105 presently attached to the vehicle 100. Because the user may be presented with images of known trailers as well as the captured image of the attached trailer 105, the likelihood of the user selecting the wrong trailer 105 is greatly diminished.

At block 220, the processor 135 may associate collected vehicle data to the trailer 105 selected at block 215. For example, the processor 135 may store the distance traveled by the vehicle 100 while towing the trailer 105 in a database that associates the distance traveled to the trailer 105 selected at block 215. The database may be stored in the memory device 130. The distance traveled may be based on the output of the odometer 115, discussed above.

The process 200 may end after block 220.

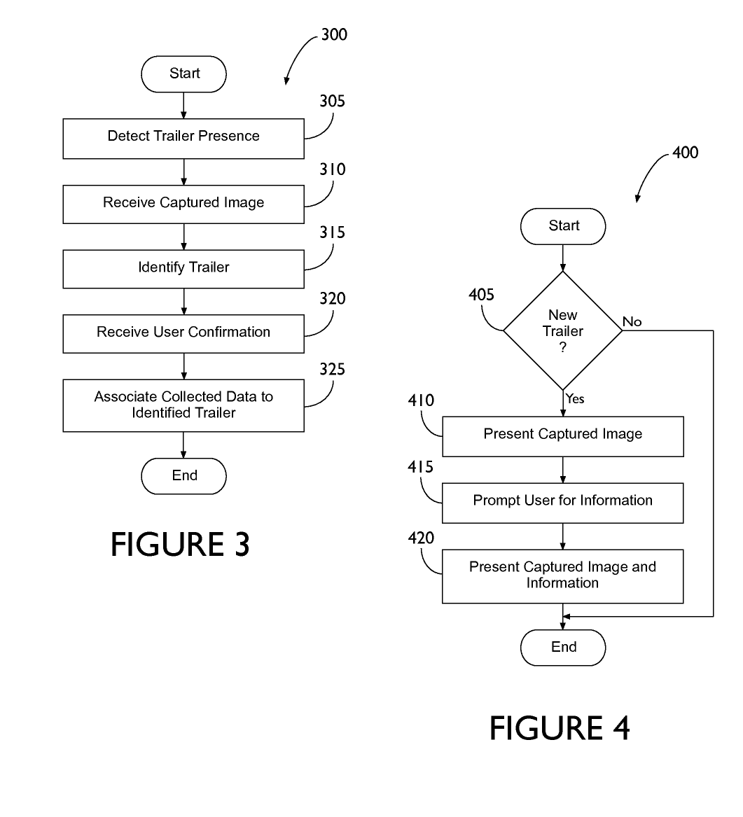

FIG. 3 illustrates an exemplary process 300 that may be implemented by, e.g., the processor 135 to automatically identify the trailer 105 connected to the vehicle 100.

At block 305, the processor 135 may detect the presence of the trailer 105 relative to the vehicle 100. As previously discussed, the vehicle 100 may include one or more sensors that determine when the trailer 105 is immediately behind the vehicle 100 or attached to the hitch 110 of the vehicle 100. The processor 135 may output a presence signal indicating the presence of the trailer 105 upon detection of the trailer 105.

At block 310, the processor 135 may receive the captured image of the trailer 105. The image may be captured as soon as the trailer 105 is detected at block 305. As discussed above, the camera 120 may capture the image of the trailer 105 upon receipt of the presence signal. The image signal representing the captured image may be transmitted from the camera 120 to the processor 135.

At block 315, the processor 135 may be configured to identify the trailer 105 from the captured image. For example, the processor 135 may compare the captured image to images of known trailers stored in the memory device 130. The processor 135 may use one or more image processing techniques to compare the captured image to the images of known trailers, including identifying the current trailer 105 based on similarities between the captured image and one of the images of known trailers. The output of the image processing technique may include a signal representing a degree of similarity between the captured image and one or more of the images of known trailers. The processor 135 may identify a match if the degree of similarity between the captured image and one of the images of known trailers exceeds a predetermined threshold. Alternatively or in addition, the processor 135 may select the trailer 105 shown in the image with the highest degree of similarity with the captured image as the selected trailer 105.

At block 320, the processor 135 may receive confirmation from the user that the correct trailer 105 was identified at block 315. For instance, the processor 135 may prompt the user, via the user interface device 125, to confirm that the trailer 105 identified at block 315 is the trailer 105 attached to the vehicle 100. The captured image may be displayed on the user interface device 125 to help the user confirm whether the correct trailer 105 was identified and reduce the likelihood that the wrong trailer 105 will be selected.

At block 325, the processor 135 may associate collected vehicle data to the trailer 105 confirmed at block 320. For example, the processor 135 may store the distance traveled by the vehicle 100 while towing the trailer 105 in a database that associates the distance traveled to the trailer 105 confirmed at block 320. The database may be stored in the memory device 130.

The process 300 may end after block 325.

FIG. 4 is a flowchart of an exemplary process 400 that may be implemented by, e.g., the processor 135 if the trailer 105 has never been connected to the vehicle 100 before. In some instances, the process 400 may be implemented if the user can indicate that the trailer 105 is a new trailer 105 at, e.g., block 210 of FIG. 2 or block 320 of FIG. 3. Alternatively, the process 400 may start if the processor 135 is unable to automatically identify a trailer 105 at block 315 of FIG. 3.

At decision block 405, the processor 135 may determine whether the trailer 105 is a new trailer 105 relative to the vehicle 100. A new trailer 105 may include a trailer 105 that has never been previously attached to the vehicle 100. The processor 135 may determine whether the trailer 105 is a new trailer 105 from a user input or if the processor 135 is unable to match the captured image of the trailer 105 to any images of known trailers stored in the memory device 130. If the trailer 105 is a new trailer 105, the process 400 may continue at block 410. If the trailer 105 is not a new trailer 105, the process 400 may end by returning to block 215 of FIG. 2 or block 315 of FIG. 3.

At block 410, the processor 135 may present the captured image to the user via, e.g., the user interface device 125. The image of the trailer 105 may have been captured by the camera 120 in response to detecting the presence of the trailer 105 at block 205 of FIG. 2 or at block 305 of FIG. 3. The camera 120 may output the image signal representing the captured image to the processor 135, and the processor 135 may present the captured image to the user via the user interface device 125 after receiving the image signal. In one possible approach, the processor 135 may retrieve the captured image from the memory device 130 instead of receiving the captured image directly from the camera 120.

At block 415, the processor 135 may prompt the user to provide information about the captured image. Example information that may be requested may include the name of the trailer 105, an identifier such as a serial number, a make and model of the trailer 105, a date of purchase, maintenance history of the trailer 105, and miscellaneous notes about the trailer 105. Other information may be requested as well.

At block 420, the processor 135 may store the captured image and the information received at block 415 in the memory device 130. In one possible approach, the captured image may be stored in the memory device 130 by the camera 120. That is, the camera 120 may transmit the image signal directly to the memory device 130, in which case the processor 135 may access the captured image from the memory device 130 at block 410, above. The captured image may be stored in the memory device 130 with other images of known trailers.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1. A system comprising:
a camera configured to capture an image of a trailer attached to a vehicle and output a signal representing the captured image;
a user interface device configured to present the captured image to a user and receive a user input; and
a processor configured to associate collected vehicle data to the trailer based at least in part on the user input.

2. The system of claim 1, wherein the processor is configured to identify the trailer from the captured image and prompt the user, via the user interface device, to confirm that the identified trailer matches the captured image.

3. The system of claim 1, wherein the processor is configured to prompt the user, via the user interface device, to provide information about the trailer represented by the captured image, and wherein the user input includes the information about the trailer.

4. The system of claim 3, wherein the processor is configured to associate the information about the trailer to the captured image and store the information and the captured image in a memory device.

5. The system of claim 1, wherein the processor is configured to determine if the trailer attached to the vehicle is a new trailer.

6. The system of claim 1, further comprising a memory device configured to store a plurality of images of known trailers including the captured image, and wherein the user interface device is configured to present the plurality of images of known trailers to the user via the user interface device, wherein the user input includes a selection of at least one of the plurality of images of known trailers.

7. The system of claim 1, further comprising an odometer configured to track a distance traveled by the vehicle, wherein the collected vehicle data includes at least a subset of the distance traveled by the vehicle.

8. A vehicle comprising:
a trailer;
a camera configured to capture an image of the trailer and output a signal representing the captured image;
a user interface device configured to present the captured image to a user and receive a user input;
an odometer configured to track a distance traveled by the vehicle while towing the trailer; and
a processor configured to identify the trailer from the captured image and associate the distance traveled by the vehicle to the trailer based at least in part on the user input, wherein the user input confirms that the trailer identified by the processor is the trailer represented by the captured image.

9. The vehicle of claim 8, wherein the processor is configured to prompt the user, via the user interface device, to confirm that the identified trailer matches the captured image.

10. The vehicle of claim 8, wherein the processor is configured to prompt the user, via the user interface device, to provide information about the trailer represented by the captured image, and wherein the user input includes the information about the trailer.

11. The vehicle of claim 10, wherein the processor is configured to associate the information about the trailer to the captured image and store the information and the captured image in a memory device.

12. The vehicle of claim 8, wherein the processor is configured to determine if the trailer attached to the vehicle is a new trailer.

13. The vehicle of claim 8, further comprising:
a memory device configured to store a plurality of images of known trailers including the captured image,
wherein the user interface device is configured to present the plurality of images of known trailers to the user via the user interface device, and
wherein the user input includes a selection of at least one of the plurality of images of known trailers.

14. A method comprising:
capturing an image of a trailer attached to a vehicle;
receiving a signal representing the captured image;
presenting the captured image to a user;
receiving a user input; and
associating, via a processor, collected vehicle data to the trailer based at least in part on the user input.

15. The method of claim 14, further comprising:
identifying the trailer from the captured image; and
prompting the user to confirm that the identified trailer matches the captured image.

16. The method of claim 14, further comprising prompting the user to provide information about the trailer represented by the captured image, wherein the user input includes the information about the trailer.

17. The method of claim 16, further comprising storing the information and the captured image in a memory device.

18. The method of claim 14, further comprising determining if the trailer attached to the vehicle is a new trailer.

19. The method of claim 14, further comprising:
storing a plurality of images of known trailers including the captured image in a memory device,
wherein presenting the captured image to the user includes presenting the plurality of images of known trailers, including the captured image, to the user and wherein receiving the user input includes a selection of at least one of the plurality of images of known trailers.

20. The method of claim 14, further comprising tracking a distance traveled by the vehicle, wherein the collected vehicle data includes at least a subset of the distance traveled by the vehicle.
